(19) United States
(12) Patent Application Publication
(10) Pub. No.: US 2009/0060132 A1
(43) Pub. Date: Mar. 5, 2009

(54) HEAT-SENSITIVE TRANSFER IMAGE-RECEIVING SHEET, IMAGE-FORMED METHOD AND IMAGE PRINTS

(75) Inventors: Junichiro HOSOKAWA, Minami-ashigara-shi (JP); Hideyuki SHIRAI, Minami-ashigara-shi (JP); Kazuaki OGUMA, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/202,093

(22) Filed: Aug. 29, 2008

(30) Foreign Application Priority Data
Aug. 30, 2007 (JP) 2007-224370

(51) Int. Cl. G01N 23/20; B41M 5/40

(52) U.S. Cl. 378/70; 428/32.39

(57) ABSTRACT

A heat-sensitive transfer image-receiving sheet having at least one receptor layer and at least one heat insulation layer on a support, wherein a Vickers hardness of the heat insulation layer is in the range of from 2 to 20, and a moisture content of the heat-sensitive transfer image-receiving sheet is in the range of from 5% by mass to 8% by mass.

### FIELD OF THE INVENTION

The present invention relates to a heat-sensitive transfer image-receiving sheet, an image-forming method and image prints produced thereby. The present invention also relates to techniques that enable to improve a print quality.

### BACKGROUND OF THE INVENTION

Various heat transfer recording methods have been known so far. Among these methods, dye diffusion transfer recording systems attract attention as a process that can produce a color hard copy having an image quality closest to that of silver halide photography. In this dye diffusion transfer recording system, a heat-sensitive transfer sheet (hereinafter also referred to as an ink sheet) containing colorants is superposed on a heat-sensitive transfer image-receiving sheet (hereinafter also referred to as an image-receiving sheet), and then the ink sheet is heated by a thermal head whose exothermic action is controlled by electric signals, in order to transfer the colorants contained in the ink sheet to the image-receiving sheet, thereby recording an image information. Three colors: cyan, magenta, and yellow, are used for recording a color image by overlapping one color to other, thereby enabling transferring and recording a color image having continuous gradation for color densities. Therefore, the thus-obtained image excels in middle tone reproducibility and gradation expression, so that extremely high-definition image can be obtained.

Besides, the dye diffusion transfer recording system has additional advantages such that imaging can be performed by a dry process, a visual image can be directly formed from digital data, and duplication is simple. Accordingly, the dye diffusion transfer recording system is developing a market of the full color hard-copy system.

On the other hand, JP-A-2006-130892 (“JP-A” means unexamined published Japanese patent application) proposes to control compression modulus, print smoothness and glossiness for improvement of pin holes (white deletion) and uneven brightness of the heat-sensitive transfer image-receiving sheet. However, satisfaction is not always obtained by control of these properties. Besides, there are various kinds of properties in which heat-sensitive transfer image-receiving sheets are required. Those include excellent finished quality of the copy print, high transfer property of the dye, long term stability of the formed image, or minimum change in property during reservation of the heat-sensitive transfer image-receiving sheet. Accordingly, further improvement has been strongly desired.

### SUMMARY OF THE INVENTION

The present invention resides in a heat-sensitive transfer image-receiving sheet having at least one receptor layer and at least one heat insulation layer on a support, wherein a Vickers hardness of the heat insulation layer is in the range of from 2 to 20, and a moisture content of the heat-sensitive transfer image-receiving sheet is in the range of from 5% by mass to 8% by mass.

Further, the present invention resides in an image-lorming method which comprises contacting a heat-sensitive transfer image-receiving sheet having at least one receptor layer and at least one heat insulation layer on a support with a heat-sensitive transfer sheet having at least one yellow dye layer, at least one magenta dye layer and at least one cyan dye layer, and then heating them to form a dye image on the receptor layer on a support, wherein a Vickers hardness of the heat insulation layer of the heat-sensitive transfer image-receiving sheet is in the range of from 2 to 20, and a moisture content of the heat-sensitive transfer image-receiving sheet is in the range of from 5% by mass to 8% by mass.

Further, the present invention resides in an image print wherein the image is formed according to the image-forming method as described above.

Other and further features and advantages of the invention will appear more fully from the following description.

### DETAILED DESCRIPTION OF THE INVENTION

The present invention provides the following means:
(1) A heat-sensitive transfer image-receiving sheet having at least one receptor layer and at least one heat insulation layer on a support, wherein a Vickers hardness of the heat insulation layer is in the range of from 2 to 20, and a moisture content of the heat-sensitive transfer image-receiving sheet is in the range of from 5% by mass to 8% by mass.
(2) An image-forming method which comprises contacting a heat-sensitive transfer image-receiving sheet having at least one receptor layer and at least one heat insulation layer on a support with a heat-sensitive transfer sheet having at least one yellow dye layer, at least one magenta dye layer and at least one cyan dye layer on a support, and then heating them to form a dye image on the receptor layer, wherein a Vickers hardness of the heat insulation layer of the heat-sensitive transfer image-receiving sheet is in the range of from 2 to 20, and a moisture content of the heat-sensitive transfer image-receiving sheet is in the range of from 5% by mass to 8% by mass.
(3) The image-forming method as described in (2), wherein the back side of the support (the side of the support opposite to the dye layer side) contains at least one Mg compound and at least one phosphorus atom-containing compound.
(4) An image print wherein the image is formed according to the image-forming method as described in (2) or (3).

The present invention is explained in detail below.

The heat-sensitive transfer image-receiving sheet of the present invention (hereinafter also referred to as the image-receiving sheet of the present invention) preferably has at least one receptor layer (dye receptor layer) on a support, and at least one heat insulation layer (porous layer) between the support and the receptor layer. Further, between the support and the receptor layer, there may be formed an interlayer having various functions such as white back ground controlling, antistatic, adhesion, and leveling functions. Further, a release layer may be formed at the outermost layer on the side of which a heat-sensitive transfer sheet is superposed.

In the present invention, it is preferred that at least one of the receptor layer, the heat insulation layer and the interlayer be coated with using an aqueous type coating liquid. Coating of each layer may be performed by an ordinary method such as roll coat, bar coat, gravure coat, gravure reverse coat, die coat, slide coat, and curtain coat. Each of the receptor layer, the heat insulation layer and the interlayer may be coated individually, or an arbitrary combination of these layers may be simultaneously multilayer coated.

On the side of the support opposite to the receptor layer coating side, a curl adjusting layer, a recording layer or a static adjusting layer may be disposed.

### (Receptor Layer)

The heat-sensitive transfer image-receiving sheet of the present invention has at least one receptor layer having a thermoplastic receptive polymer capable of receiving at least a dye.

Examples of preferable receptive polymers include vinyl-based resins such as polyvinyl acetate, ethylene vinyl acetate copolymer, vinyl chloride vinyl acetate copolymer, vinyl chloride acrylate copolymer, vinyl chloride methacrylate copolymer, polyacrylic ester, polystyrene, and acrylic polystyrene; acetal resins such as polyvinyl formal, polyvinyl butyral, and polyvinyl acetal; polyester resins such as polyethyleneterephthalate, polybutyleneterephthalate and polycaprolactone; polycarbonate-based resins; polyurethane-based resins; cellulose-based resins; polyolefin-based resins such as polypropylene; polyamide-based resin; and amino resins such as urea resins, melamine resins and benzoguanamine resins. These resins may be used optionally blending with each other in the range of compatibility.

It is further preferable, among these polymers, to use a polycarbonate, a polyester, a polyurethane, a polyvinyl chloride or a copolymer of vinyl chloride, a styrene-acrylonitrile copolymer, a polycaprolactone or a mixture of two or more of these. It is particularly preferable to use a polyester, a polyvinyl chloride or a copolymer of vinyl chloride, or a mixture of these.

The above-exemplified polymers may be dissolved in a proper organic solvent such as methyl ethyl ketone, ethyl acetate, benzene, toluene, and xylene so that they can be coated on a support. Alternatively, they may be added to a water-based coating liquid as latex polymer so that they can be coated on a support.

Further, the receptor layer may contain ultraviolet absorbents, release agents, sliding agents, antioxidants, antiseptics, and surfactants.

### <Latex Polymer>

It is preferred to contain latex polymer in a receptor layer that is coated in the heat-sensitive transfer image-receiving sheet of the present invention.

The latex polymer for use in the receptor layer is a dispersion in which water-insoluble hydrophobic polymers are dispersed as fine particles in a water-soluble dispersion medium. The dispersed state may be one in which polymer is emulsified in a dispersion medium, one in which polymer underwent emulsion polymerization, one in which polymer underwent micelle dispersion, one in which polymer molecules partially have a hydrophilic structure and thus the molecular chains themselves are dispersed in a molecular state, or the like. The dispersed particles preferably have a mean average particle size (diameter) of about 1 to 50,000 nm, more preferably about 5 to 1,000 nm.

The glass transition temperature (Tg) of the latex polymer that can be used in the present invention is preferably −30° C. to 120° C., more preferably 0° C. to 100° C., further preferably 10° C. to 80° C., and further more preferably 20° C. to 70° C.

The glass transition temperature (Tg) is calculated according to the following equation:

1/Tg=Σ(Xi/Tgi)

wherein, assuming that the polymer is a copolymer composed of n monomers from i=1 to i=n, Xi is a mass fraction of the i-th monomer (ΣXi=1) and Tgi is a glass transition temperature (absolute temperature scale) of a homopolymer formed from the i-th monomer. The symbol Σ means the sum of i=1 to i=n. The value of the glass transition temperature of a homopolymer formed from each monomer (Tgi) can be adopted from J. Brandrup and E. H. Immergut, “Polymer Handbook, 3rd. Edition”, Wiley-Interscience (1989).

In a preferable embodiment of the latex polymer used in the heat-sensitive transfer image-receiving sheet according to the present invention, latex polymers such as acrylic-series polymers, polyesters, rubbers (e.g., SBR resins), polyurethanes, polyvinyl chloride copolymers including copolymers such as vinyl chloride/vinyl acetate copolymer, vinyl chloride/acrylate copolymer, and vinyl chloride/methacrylate copolymer; polyvinyl acetate copolymers including copolymers such as ethylene/vinyl acetate copolymer; and polyolefins, are preferably used. These latex polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number-average molecular weight.

The latex polymer according to the present invention is preferably exemplified by any one of polyester latexes; vinyl chloride latex copolymers such as vinyl chloride/acrylic compound latex copolymer, vinyl chloride/vinyl acetate latex copolymer, and vinyl chloride/vinyl acetate/acrylic compound latex copolymer, or arbitrary combinations thereof.

Examples of the vinyl chloride copolymer include those described above. Among these, VINYBLAN 240, VINYBLAN 270, VINYBLAN 276, VINYBLAN 277, VINYBLAN 375, VINYBLAN 380, VINYBLAN 386, VINYBLAN 410, VINYBLAN 430, VINYBLAN 432, VINYBLAN 550, VINYBLAN 601, VINYBLAN 602, VINYBLAN 609, VINYBLAN 619, VINYBLAN 680, VINYBLAN 680S, VINYBLAN 681N, VINYBLAN 683, VINYBLAN 685R, VINYBLAN 690, VINYBLAN 860, VINYBLAN 863, VINYBLAN 865, VINYBLAN 867, VINYBLAN 900, VINYBLAN 938 and VINYBLAN 950 (trade names, manufactured by Nissin Chemical Industry Co., Ltd.); and SE1320, S-830 (trade names, manufactured by Sumica Chemtex) are preferable.

### (Polyester-Series Latexes)

The polyester-series latex is preferably exemplified by VIRONAL MD1200, VIRONAL MD1220, VIRONAL MD1245, VIRONAL MD1250, VIRONAL MD1500, VIRONAL MD1930, and VIRONAL MD1985 (trade names, manufactured by Toyobo Co., Ltd.).

Among these, vinyl chloride-series latex copolymers such as a vinyl chloride/acrylic compound latex copolymer, a vinyl chloride/vinyl acetate latex copolymer, a vinyl chloride/vinyl acetate/acrylic compound latex copolymer, are more preferable.

### <Water-Soluble Polymer>

In the heat-sensitive transfer image-receiving sheet of the present invention, it is one of preferred embodiments of the present invention that the receptor layer contains a water-soluble polymer.

Herein, the “water-soluble polymer” means a polymer which dissolves, in 100 g of water at 20° C., in an amount of preferably 0.05 g or more, more preferably 0.1 g or more, further preferably 0.5 g or more, and particularly preferably 1 g or more. As the water-soluble polymers, natural polymers, semi-synthetic polymers and synthetic polymers are preferably used.

Among the water-soluble polymer that can be used in the heat-sensitive transfer image-receiving sheet of the present invention, the natural polymers and the semi-synthetic polymers will be explained in detail. Specific examples include the following polymers: plant type polysaccharides such as κ-carrageenans, ι-carrageenans, λ-carrageenans, and pectins; microbial type polysaccharides such as xanthan gums and dextrins; animal type natural polymers such as gelatins and caseins; and cellulose-based polymers such as carboxymethylcelluloses, hydroxyethylcelluloses, and hydroxypropylcelluloses.

Of the natural polymers and the semi-synthetic polymers that can be used in the present invention, gelatin is preferred. Gelatin having a molecular mass of from 10,000 to 1,000,000 may be used in the present invention.

Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

Of the water-soluble polymers that can be used in the heat-sensitive transfer image-receiving sheet of the present invention, examples of the synthetic polymers include polyvinyl pyrrolidone, polyvinyl pyrrolidone copolymers, polyvinyl alcohol, polyethylene glycol, polypropylene glycol, and water-soluble polyesters.

Among the synthetic polymers that can be used in the present invention, polyvinyl alcohols are preferable.

As the polyvinyl alcohol, there can be used various kinds of polyvinyl alcohols such as complete saponification products thereof, partial saponification products thereof, and modified polyvinyl alcohols. With respect to these polyvinyl alcohols, those described in Koichi Nagano, et al., “Poval”, Kobunshi Kankokai, Inc. are useful.

The viscosity of polyvinyl alcohol can be adjusted or stabilized by adding a trace amount of a solvent or an inorganic salt to an aqueous solution of polyvinyl alcohol, and use may be made of compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid to be added is preferably 0.01 to 40 mass %, with respect to polyvinyl alcohol.

Specific examples of the polyvinyl alcohols include completely saponificated polyvinyl alcohol such as PVA-105, PVA-110, PVA-117 and PVA-117H (trade names, manufactured by KURARAY CO., LTD.); partially saponificated polyvinyl alcohol such as PVA-203, PVA-205, PVA-210 and PVA-220 (trade names, manufactured by KURARAY CO., LTD.); and modified polyvinyl alcohols such as C-118, HL-12E, KL-118 and MP-203 (trade names, manufactured by KURARAY CO., LTD.).

A preferable addition amount of the latex polymer is in the range of from 50% by mass to 98% by mass, more preferably from 70% by mass to 95% by mass, in terms of solid content of the latex polymer in the receptor layer.

In the heat-sensitive transfer image-receiving sheet of the present invention, at least one receptor layer may be coated with an aqueous type coating liquid. In the case where the image-receiving sheet has a plurality of receptor layers, it is preferred to coat all of these layers with an aqueous type coating liquid, followed by drying for production. The “aqueous type” here means that 60% by mass or more of the solvent (dispersion medium) of the coating liquid is water. As a component other than water in the coating liquid, a water miscible organic solvent may be used. Examples thereof include methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether.

### (Ultraviolet Absorbent)

The heat-sensitive transfer image-receiving sheet of the present invention may contain any ultraviolet absorbents. As the ultraviolet absorbents, use can be made of conventionally known inorganic or organic ultraviolet absorbents. As the organic ultraviolet absorbents, use can be made of non-reactive ultraviolet absorbents such as salicylate-series, benzophenone-series, benzotriazole-series, triazine-series, substituted acrylonitrile-series, and hindered amine-series ultraviolet absorbents; copolymers or graft polymers of thermoplastic resins (e.g., acrylic resins) obtained by introducing an addition-polymerizable double bond (eg., a vinyl group, an acryroyl group, a methacryroyl group), or an alcoholic hydroxyl group, an amino group, a carboxyl group, an epoxy group, or an isocyanate group, to the non-reactive ultraviolet absorbents, subsequently copolymerizing or grafting. In addition, disclosed is a method of obtaining ultraviolet-shielding resins by the steps of dissolving ultraviolet absorbents in a monomer or oligomer of the resin to be used, and then polymerizing the monomer or oligomer (JP-A-2006-21333). In this case, the ultraviolet absorbents may be non-reactive.

Of these ultraviolet absorbents, preferred are benzophenone-series, benzotriazole-series, and triazine-series ultraviolet absorbents. It is preferred that these ultraviolet absorbents are used in combination so as to cover an effective ultraviolet absorption wavelength region according to characteristic properties of the dye that is used for image formation. Besides, in the case of non-reactive ultraviolet absorbents, it is preferred to use a mixture of two or more kinds of ultraviolet absorbents each having a different structure from each other so as to prevent the ultraviolet absorbents from precipitation.

Examples of commercially available ultraviolet absorbents include TINUVIN-P (trade name, manufactured by Ciba-Geigy), JF-77 (trade name, manufactured by JOHOKU CHEMICAL CO., LTD.), SEESORB 701 (trade name, manufactured by SHIRAISHI CALCIUM KAISHA, LTD.), SUMISORB 200 (trade name, manufactured by Sumitomo Chemical Co., Ltd.), VIOSORB 520 (trade name, manufactured by KYODO CHEMICAL CO., LTD.), and ADKSTAB LA-32 (trade name, manufactured by ADEKA).

### <Release Agent>

To the heat-sensitive transfer image-receiving sheet of the present invention, a release agent may be added to secure a releasing property between the heat-sensitive transfer sheet and the heat-sensitive transfer image-receiving sheet at the time of image printing.

As the release agent, there can be used, for example, solid waxes such as polyethylene wax, paraffin wax, fatty acid ester wax, and amide wax; and silicone oil, phosphoric ester-based compounds, fluorine-based surfactants, silicone-based surfactants, and other release agents known in this technical field. Of these release agents, preferred are fatty acid ester waxes, fluorine-based surfactants, and silicone-based compounds such as silicone-based surfactants, silicone oil and/or hardened products thereof.

### <Surfactant>

Further in the heat-sensitive transfer image-receiving sheet of the present invention, a surfactant may be contained in any of such layers as described above. Of these layers, it is preferable to contain the surfactant in the receptor layer and the intermediate layer.

An addition amount of the surfactant is preferably from 0.01% by mass to 5% by mass, more preferably from 0.01% by mass to 1% by mass, and especially preferably from 0.02% by mass to 0.2% by mass, based on the total solid content.

With respect to the surfactant, various kinds of surfactants such as anionic, nonionic and cationic surfactants are known. As the surfactant that can be used in the present invention, any known surfactants may be used. For example, it is possible to use surfactants as reviewed in “Kinosei kaimenkasseizai (Functional Surfactants)”, editorial supervision of Mitsuo Tsunoda, edition on August in 2000, Chapter 6. Of these surfactants, fluorine-containing anionic surfactants are preferred.

### <Matting Agent>

To the heat-sensitive transfer image-receiving sheet of the present invention, a matting agent may be added in order to prevent blocking, or to give a release property or a sliding property. The matting agent may be added on the same side as the coating side of the receptor layer, or on the side opposite to the coating side of the receptor layer, or on both sides.

In the present invention, examples of the matting agent generally include fine particles of water-insoluble organic compounds and fine particles of water-insoluble inorganic compounds. In the present invention, the organic compound-containing fine particles are used from the viewpoints of dispersion properties. In so far as the organic compound is incorporated in the particles, there may be organic compound particles consisting of the organic compound alone, or alternatively organic/inorganic composite particles containing not only the organic compound but also an inorganic compound. As the matting agent, there can be used organic matting agents described in, for example, U.S. Pat. No. 1,939,213, U.S. Pat. No. 2,701,245, U.S. Pat. No. 2,322,037, U.S. Pat. No. 3,262,782, U.S. Pat. No. 3,539,344, and U.S. Pat. No. 3,767,448.

### <Antiseptic>

To the heat-sensitive transfer image-receiving sheet of the present invention, antiseptics may be added. The antiseptics that may be used in the image-receiving sheet of the invention are not particularly limited. For example, use can be made of materials described in Bofubokabi (Preservation and Antifungi) HAND BOOK, Gihodo shuppan (1986), Bokin Bokabi no Kagaku (Chemistry of Anti-bacteria and Anti-fungi) authored by Hiroshi Horiguchi, Sankyo Shuppan (1986), Bokin Bokabizai Jiten (Encyclopedia of Antibacterial and Antifungal Agent) edited by The Society for Antibacterial and Antifungal Agent, Japan (1986). Examples thereof include imidazole derivatives, sodium dehydroacetate, 4-isothiazoline-3-on derivatives, benzoisothiazoline-3-on, benzotriazole derivatives, amidineguanidine derivatives, quaternary ammonium salts, pyrrolidine, quinoline, guanidine derivatives, diazine, triazole derivatives, oxazole, oxazine derivatives, and 2-mercaptopyridine-N-oxide or its salt. Of these antiseptics, 4-isothiazoline-3-on derivatives and benzoisothiazoline-3-on are preferred.

The coating amount of the receptor layer is preferably 0.5 to 10 g/m² (solid basis, hereinafter, the amount to be applied in the present specification means a value on solid basis, unless otherwise specified). The film thickness of the receptor layer is preferably in the range of from 1 μm to 20 μm.

### (Heat Insulation Layer)

The heat insulation layer that is coated in the heat-sensitive transfer image-receiving sheet of the present invention may be a single layer or double or more multiple layers. The heat insulation layer is disposed between the support and the receptor layer.

In the heat-sensitive transfer image-receiving sheet according to the present invention, the heat insulation layer preferably contains hollow polymer particles.

The hollow polymer particles in the present invention are polymer particles having voids inside of the particles. The hollow polymer particles are preferably aqueous dispersion. Examples of the hollow polymer particles include (1) non-foaming type hollow particles obtained in the following manner: a dispersion medium such as water is contained inside of a capsule wall formed of a polystyrene, acrylic resin, or styrene/acrylic resin, and, after a coating liquid is applied and dried, the water in the particles is vaporized out of the particles, with the result that the inside of each particle forms a hollow; (2) foaming type microballoons obtained in the following manner: a low-boiling-point liquid such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling-point liquid inside of the particles, whereby the inside of each particle is made to be hollow; and (3) microballoons obtained by foaming the above (2) under heating in advance, to make hollow polymer particles.

Specific examples of the above (1) include Rohpake 1055, manufactured by Rohm and Haas Co.; Boncoat PP-1000, manufactured by Dainippon Ink and Chemicals, Incorporated; SX866(B), manufactured by JSR Corporation; and Nippol MH5055, manufactured by Nippon Zeon (all of these product names are trade names). Specific examples of the above (2) include F-30, and F-50, manufactured by Matsumoto Yushi-Seiyaku Co., Ltd. (all of these product names are trade names). Specific examples of the above (3) include F-30E, manufactured by Matsumoto Yushi-Seiyaku Co., Ltd, and Expancel 461DE, 551DE, and 551DE20, manufactured by Nippon Ferrite (all of these product names are trade names).

Of these, non-foaming hollow polymer particles of the foregoing (1) are preferred. If necessary, use can be made of a mixture of two or more kinds of polymer particles.

The average particle diameter (particle size) of the hollow polymer particles is preferably 0.1 to 5.0 μn, more preferably 0.2 to 3.0 μm, and particularly preferably 0.3 to 1.0 μm.

The hollow ratio (percentage of void) of the hollow polymer particles is preferably in the range of from about 20% to about 70%, and particularly preferably from 20% to 50%.

In the present invention, the particle size of the hollow polymer particle is calculated after measurement of the circle-equivalent diameter of the periphery of particle under a transmission electron microscope. The average particle diameter is determined by measuring the circle-equivalent diameter of the periphery of at least 300 hollow polymer particles observed under the transmission electron microscope and obtaining the average thereof.

The hollow ratio of the hollow polymer particles is calculated by the ratio of the volume of voids to the volume of a particle.

The glass transition temperature (Tg) of the hollow polymer particles that can be used in the heat-sensitive transfer image-receiving sheet of the present invention is preferably 50 to 180° C., more preferably 70 to 150° C.

It is preferred that the heat insulation layer contains a water-soluble polymer as a binder in addition to hollow polymer particles. A preferable water-soluble polymer is exemplified by water-soluble polymers described in the section of Receptor layer. Among these water-soluble polymers, gelatin and a polyvinyl alcohol are more preferable. These resins may be used either singly or as a mixture thereof.

A thickness of the heat insulation layer containing the hollow polymer particles is preferably from 5 to 50 μm, more preferably from 8 to 40 μm.

### (Interlayer)

An interlayer may be formed between the receptive layer and the support. A function of the interlayer is exemplified by white background adjustment, antistatic, imparting of adhesion and imparting of smoothness (leveling). The function of the interlayer is not limited to these, and a previously known interlayer may be provided.

### <Support>

As the support that is used for the heat-sensitive transfer image-receiving sheet of the present invention, there may be used previously known supports with a preferable example being a water-proof support. The usage of the water-proof support enables to prevent the support from absorbing moisture thereto, so that a change in properties of the receptor layer with the lapse of time can be prevented. As the water-proof support, there may be, for example, a coat paper, a laminate paper and a synthetic paper with a preferable example being a laminate paper.

### (Curl Adjusting Layer)

In the heat-sensitive transfer image-receiving sheet that is used in the present invention, if necessary, a curl adjusting layer is preferably formed. For the curl adjusting layer, for example, a polyethylene laminate and a polypropylene laminate may be used. Specifically, the curl adjusting layer may be formed in the same manner as described in, for example, JP-A-61-110135 and JP-A-6-202295.

### <Writing Layer and Charge Controlling Layer>

In the heat-sensitive transfer image-receiving sheet that is used in the present invention, if necessary, a writing layer or a charge controlling layer may be disposed. For the writing layer and the charge control layer, an inorganic oxide colloid, an ionic polymer, or the like may be used. As the antistatic agent, any antistatic agents including cationic antistatic agents such as a quaternary ammonium salt and polyamine derivative, anionic antistatic agents such as alkyl phosphate, and nonionic antistatic agents such as fatty acid ester may be used. Specifically, the writing layer and the charge control layer may be formed in a manner similar to those described in the specification of Japanese Patent No. 3585585.

### <Moisture Content>

The moisture content herein used was calculated according to JIS P 8127. Specifically, the heat-sensitive transfer image-receiving sheet was subjected to moisture adjustment for 4 days under the conditions of temperature: 25° C. and humidity: 55%, and then dried at temperature of 105° C. for 30 hours. Thereafter, masses of the image-receiving sheet before and after drying were measured.

In the present invention, it is essential that the moisture content of the heat-sensitive transfer image-receiving sheet is in the range of from 5% by mass to 8% by mass with a preferable range being from 5% by mass to 6% by mass. If the content is less than 5% by mass, uniformity of image deteriorates. On the other hand, if the content is more than 8% by mass, a trouble arises such as adhesion at both sides of a roll form of the heat-sensitive transfer image-receiving sheet.

A method of controlling the moisture content within the range of from 5% by mass to 8% by mass is not particularly limited. But, the content may be controlled by adjusting a hydrophilic nature/a hydrophobic nature of the components in the heat insulation layer, the receptor layer and other layers. Examples of preferable methods include usage of water-dispersible hollow polymer in the heat insulation layer, usage of hydrophilic polymers such as gelatin and polyvinyl alcohol as a binder, and usage of water-dispersible latex in the receptor layer. Besides, it is also preferred to add a humectant such as glycerin, sorbitol and urea in the heat insulation layer or a receptor layer.

### <Vickers Hardness>

The Vickers hardness herein used is a value that is measured using, for example, full automatic micro Vickers hardness-meter system (trade name: HMV-FA, manufactured by Shimadzu).

The Vickers hardness can be calculated according to the universal hardness computing equation set forth below, based on the applied load and indentation depth of an indenting tool that is obtained by applying a load to the indenting tool.

Vickers hardness UHV=37.838×P/(D×D)

In the above, P represents a test load (m N), and D represents an indentation depth (μm).

The above measuring conditions are explained in more detail.

The test conditions are as follows. Using the full automatic micro Vickers hardness-meter system (trade name: HMV-FA, manufactured by Shimadzu), 100 m N of test load is applied with a Vickers indenting tool at the speed of 10 m N/sec. Based on the applied load and indentation depth of the indenting tool, the Vickers hardness is calculated according to the above-described computing equation.

Taking the high speed copy printer suitability into consideration, a fast application speed of test load is preferred. Specifically, the speed is preferably in the range of from 0.01 m N/sec to 100 m N/sec, more preferably from 0.05 m N/sec to 100 m N/sec, and most preferably from 0.1 m N/sec to 100 m N/sec.

In the present invention, a single film sample of the heat insulation layer of the heat-sensitive transfer image-receiving sheet that is used for measurement of Vickers hardness can be conducted by coating a single film of the heat insulation layer on a glass film plate, and after drying, followed by carefully peeling the single film of the heat insulation layer formed on the glass film plate.

In the present invention, Vickers hardness of the single film of the heat insulation layer is preferably in the range of from 2 to 20, more preferably from 2 to 15, and furthermore preferably from 2 to 10. If the Vickers hardness is more than 20, image uniformity deteriorates. On the other hand, if the Vickers hardness is less than 2, a damage sometimes occurs owing to, for example, friction and scratch on the heat-sensitive transfer image-receiving sheet before printing.

In the present invention, a method of controlling the Vickers hardness of the single film of the heat insulation layer to the range of from 2 to 20 is not particularly limited. For example, the Vickers hardness may be controlled by a change of physical properties of hollow polymers (e.g., polymer size, porosity, wall materials of the hollow polymer), or a change of a content of the hollow polymer in the heat insulation layer, or a change of kinds of binders of the heat insulation layer. Alternatively, the Vickers hardness may be controlled by adding materials capable of softening a binder, or a plasticizer for the hollow polymer.

As an effective method to limit the Vickers hardness in the range according to the present invention, it is exemplified to limit the hollowness of the hollow polymer particles in the range of 30 mass % to 50 mass % with respect to the hollow polymer particle. When the hollowness becomes too small, the hardness of the heat insulation layer becomes high. On the contrary, when the hollowness becomes too large, the strength of the hollow polymer particles themselves decrease and the shapes thereof deform at the time of image printing, so problems, for example, impairing of the flatness of surfaces of the prints, are apt to arise.

Further, it is also an effective method to use a polymer having an appropriate range of glass transition temperature (Tg) as a wall material of the hollow polymer particles. The appropriate range of Tg is, for example, preferably 50° C. to 100° C., more preferably 60° C. to 80° C. When the Tg of the hollow polymer particles becomes too high, image uniformity deteriorates. On the contrary, when the Tg of the hollow polymer particles becomes too low, the heat durability of the hollow polymer particles decreases so the heat insulation property is damaged and problems such as a decrease of print density occur.

Further, it is also effective to add a soft polymer in the insulation layer. Preferable examples thereof include latex polymers having a Tg within the range from 40° C. to 60° C. The amount of these latex polymers to be added is preferably 1 to 30 mass %, more preferably 2 to 10 mass % with respect to the insulation layer. In a preferable embodiment of the latex polymer, use may be preferably made of latex polymers, for example, of acrylic-series polymers, polyesters, rubbers (e.g., SBR resins), polyurethanes, polyvinyl series polymers; polyvinyl chloride copolymers including copolymers, such as vinyl chloride/vinyl acetate copolymer, vinyl chloride/acrylate copolymer; and vinyl chloride/methacrylate copolymer; polyvinyl acetate copolymers including copolymers, such as ethylene/vinyl acetate copolymer; styrene/butyl acrylate copolymer, styrene/2-ethylhexyl acrylate copolymer, and styrene/methyl methacrylate/butyl acrylate copolymer, and polyolefins. These latex polymers may be straight-chain, branched, or cross-linked polymers, the so-called homopolymers obtained by polymerizing single type of monomers, or copolymers obtained by polymerizing two or more types of monomers.

Further, a jelly-like substance such as carrageenan is also effective as a softener of the heat insulation layer. The amount of such a substance to be added is preferably 1 to 30 mass %, more preferably 2 to 10 mass % with respect to the heat insulation layer.

It is preferable to use a gelatin binder in the heat insulation layer for use in the present invention, and it is also effective to use the gelatin binder in combination with urea or a polyhydric alcohol such as glycerin, and carrageenan, as materials of softers.

Further, as the plasticizer to soften the hollow polymer particles, use may be preferably made of any of phosphoric esters, phthalic acid esters, adipic acid esters, glycol esters, and maleic acid esters. The amount of the plasticizer to be added is preferably 1 to 10 mass %, more preferably 2 to 5 mass % with respect to the hollow polymer particles.

In the image-forming method of the present invention, imaging is achieved by superposing the heat-sensitive transfer sheet on the heat-sensitive transfer image-receiving sheet so that a heat transfer layer of the heat-sensitive transfer sheet is in contact with the receptor layer of the heat-sensitive transfer image-receiving sheet and giving thermal energy in accordance with image signals given from a thermal head.

Specifically, image-forming can be achieved by the similar manner to that as described in, for example, JP-A-2005-88545. In the present invention, a printing time is preferably less than 15 seconds, and more preferably in the range of 3 to 12 seconds, and further more preferably in the range of 3 to 7 seconds, from the viewpoint of shortening a time taken until a consumer gets a print.

In order to accomplish the above-described printing time, a line speed at the time of printing is preferably 0.73 m sec/line or less, more preferably 0.65 m sec/line or less. Further, from the viewpoint of improvement in transfer efficiency as one of speeding-up conditions, the maximum ultimate temperature of the thermal head at the time of printing is preferably in the range of from 180° C. to 450° C., more preferably from 200° C. to 450° C., and furthermore preferably from 350° C. to 450° C.

The method of the present invention may be utilized for printers, copying machines and the like, which employs a heat-sensitive transfer recording system. As a means for providing heat energy in the thermal transfer, any of the conventionally known providing means may be used. For example, application of a heat energy of about 5 to 100 mJ/mm² by controlling recording time in a recording device such as a thermal printer (e.g., trade name: Video Printer VY-100, manufactured by Hitachi, Ltd.), sufficiently attains the expected result. Further, the heat-sensitive transfer image-receiving sheet for use in the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

### <Heat-Sensitive Transfer Sheet>

The heat-sensitive transfer sheet according to the present invention is described below.

### (Dye Layer)

In the dye layer according to the present invention, preferably, dye layers in individual colors of yellow, magenta, and cyan, and an optional dye layer in black are repeatedly painted onto a single support in area order in such a manner that the colors are divided from each other. An example of the dye layer is an embodiment wherein dye layers in individual colors of yellow, magenta, and cyan are painted onto a single support along the long axial direction thereof in area order, correspondingly to the area of the recording surface of the above-mentioned heat-sensitive transfer image-receiving sheet, in such a manner that the colors are divided from each other. Another example thereof is an embodiment wherein not only the three layers but also a dye layer in black and/or a transferable protective layer are painted in such a manner that these layers are divided from each other, and this embodiment being preferred.

In the case of adopting such an embodiment, it is preferred to give marks to the heat-sensitive transfer sheet in order to inform the printer about starting point of the individual colors. Such repeated painting in area order enables to form an image by transferring of dyes and further laminate a protective layer on the image with a single heat-sensitive transfer sheet.

In the invention, however, the manner in which the dye layer is formed is not limited to the above-mentioned manners. A sublimation heat-transferable ink layer and a heat-melt transferable ink layer may be together formed. A dye in a color other than yellow, magenta, cyan and black may be formed, or other modifications may be made. The form of the heat-sensitive transfer sheet including the dye layer may be a longitudinal form, or a one-piece form.

The dye layer may have a mono-layered structure or a multi-layered structure. In the case of the multi-layered structure, the individual layers constituting the dye layer may be the same or different in composition.

### (Dye Ink)

The dye ink for forming the dye layer generally contains at least a sublimation type dye and a binder. The ink may further contain waxes, silicone resins, and fluorine-containing organic compounds, in accordance with necessity.

Each dye in the dye layer is preferably contained in an amount of 20 to 80 mass % of the dye layer, preferably in that of 30 to 70 mass % thereof.

The coating of the dye layer (i.e., the painting of a coating liquid for the dye layer) is performed by an ordinary method such as roll coating, bar coating, gravure coating, or gravure reverse coating. The coating amount of the dye layer is preferably from 0.1 to 2.0 g/m², more preferably from 0.2 to 1.2 g/m² (the amount is a numerical value converted to the solid content in the layer; any coating amount in the following description is a numerical value converted to the solid content unless otherwise specified). The film thickness of the dye layer is preferably from 0.1 to 2.0 μm, more preferably from 0.2 to 1.2 μm.

The dyes for use in the present invention is not particularly limited, so far as the dyes are able to diffuse by heat and able to be incorporated in a heat-sensitive transfer sheet, and able to transfer by heat from the heat-sensitive transfer sheet to an image-receiving sheet. The dyes that have been conventionally used for the heat-sensitive transfer sheet or known dyes can be effectively used.

Preferable examples of the dyes that is used in the present invention include diarylmethane-series dyes, triarylmethane-series dyes, thiazole-series dyes, methine-series dyes such as merocyanine; azomethine-series dyes typically exemplified by indoaniline, acetophenoneazomethine, pyrazoloazomethine, imidazole azomethine, imidazo azomethine, and pyridone azomethine; xanthene-series dyes; oxazine-series dyes; cyanomethylene-series dyes typically exemplified by dicyanostyrene, and tricyanostyrene; thiazine-series dyes; azine-series dyes; acridine-series dyes; benzene azo-series dyes; azo-series dyes such as pyridone azo, thiophene azo, isothiazole azo, pyrol azo, pyralazo, imidazole azo, thiadiazole azo, triazole azo, and disazo; spiropyran-series dyes; indolinospiropyran-series dyes; fluoran-series dyes; rhodaminelactam-series dyes; naphthoquinone-series dyes; anthraquinone-series dyes; and quinophthalon-series dyes.

Specific examples of the yellow dyes include Disperse Yellow 231, Disperse Yellow 201 and Solvent Yellow 93. Specific examples of the magenta dyes include Disperse Violet 26, Disperse Red 60, and Solvent Red 19. Specific examples of the cyan dyes include Solvent Blue 63, Solvent Blue 36, Disperse Blue 354 and Disperse Blue 35. As a matter of course, it is also possible to use suitable dyes other than these dyes as exemplified above.

Further, dyes each having a different hue from each other as described above may be arbitrarily combined together. For instance, a black hue can be obtained from a combination of dyes.

### (Binder)

As the binder, various kinds of binder are known, and these can be used in the present invention. Examples thereof include acrylic series resins such as polyacrylonitrile, polyacrylate, and polyacrylamide; polyvinyl acetal series resins such as polyvinyl acetoacetal, and polyvinyl butyral; cellulose series resins or modified cellulose series resins such as ethylcellulose, hydroxyethylcellulose, ethylhydroxycellulose, hydroxypropylcellulose, ethylhydroxyethylcellulose, methylcellulose, cellulose acetate, cellulose acetate butyrate, cellulose acetate propionate, cellulose nitrate; other resins such as polyurethane resin, polyamide resin, polyester resin, polycarbonate resin, phenoxy resin, phenol resin, and epoxy resin; and various kinds of elastomers. The dye layer may be made of at least one resin selected from the above-mentioned group.

These may be used alone, or two or more thereof may be used in the form of a mixture or copolymer. These may be crosslinked with various crosslinking agents.

The binder in the invention is preferably a cellulose series resin or a polyvinyl acetal series resin, more preferably a polyvinyl acetal resin. Among these resins, polyvinyl acetoacetal resin and polyvinyl butyral resin are preferably used in the present invention.

In the heat-sensitive transfer sheet of the invention, a dye barrier layer may be formed between the dye layer and the support.

The surface of the support may be subjected to treatment for easy adhesion to improve the wettability and the adhesive property of the coating liquid. Examples of the treatment include corona discharge treatment, flame treatment, ozone treatment, ultraviolet treatment, radial ray treatment, surface-roughening treatment, chemical agent treatment, vacuum plasma treatment, atmospheric plasma treatment, primer treatment, grafting treatment, and other known surface modifying treatments.

An easily adhesive layer may be formed on the support by coating. Examples of the resin used in the easily adhesive layer include polyester series resins, polyacrylate series resins, polyvinyl acetate series resins, vinyl series resins such as polyvinyl chloride resin and polyvinyl alcohol resin, polyvinyl acetal resins series such as polyvinyl acetoacetal and polyvinyl butyral, polyether series resins, polyurethane series resins, styrene acrylate series resins, polyacrylamide series resins, polyamide series resins, polystyrene series resins, polyethylene series resins, and polypropylene series resins.

When a film used for the support is formed by melt extrusion, it is possible to subject a non-stretched film to coating treatment followed by stretching treatment.

The above-mentioned treatments may be used in combination of two or more thereof.

### (Transferable Protective Layer Laminate)

In the invention, a transferable protective layer laminate is preferably formed in area order onto the heat-sensitive transfer sheet. The transferable protective layer laminate is used to protect a heat-transferred image with a protective layer composed of a transparent resin, thereby to improve durability such as scratch resistance, light-fastness, and resistance to weather. This laminate is effective in the case where the transferred dye is insufficient in image durabilities such as light resistance, scratch resistance, and chemical resistance in the state that the dye is naked in the surface of the image-receiving sheet.

The transferable protective layer laminate can be formed by forming, onto the support, a releasing layer, a protective layer and an adhesive layer in this order from the support side successively. The protective layer may be formed by plural layers. In the case where the protective layer also has functions of other layers, the releasing layer and the adhesive layer can be omitted. It is also possible to use a support on which an easy adhesive layer has already been formed.

### (Transferable Protective Layer)

As a protective layer-forming resin, preferred are resins that excel in scratch resistance, chemical resistance, transparency and hardness. Examples of the resin include polyester resins, acrylic resins, polystyrene resins, polyurethane resins, acrylic urethane resins, silicone-modified resins of each of these resins, ultraviolet-shielding resins, mixtures of these resins, ionizing radiation-curable resins, and ultraviolet curable resins. Particularly preferred are polyester resins and acrylic resins.

These resins may be crosslinked with various crosslinking agents.

### (Transferable Protective Layer Resin)

As the acrylic resin, use can be made of polymers derived from at least one monomer selected from conventionally known acrylate monomers and methacrylate monomers. Monomers other than these acrylic monomers, such as styrene and acrylonitrile may be co-polymerized with the acrylic monomers. A preferred monomer is methyl methacrylate. It is preferred that methyl methacrylate is contained in terms of preparation mass ratio of 50 mass % or more in the polymer.

The acrylic resin in the invention preferably has a molecular weight of 20,000 or more and 100,000 or less. If the molecular weight is too small, oligomers are produced during synthesis. They make it difficult to maintain stability of properties. On the other hand, if the molecular weight is too large, a foil-off property deteriorates at the time when the protective layer is transferred.

The polyester resin in the invention may be a saturated polyester resin known in the prior art. As the above-described polyester resin, a preferable glass transition temperature ranges from 50° C. to 120° C., and a preferable molecular weight ranges from 2,000 to 40,000. A molecular weight ranging from 4,000 to 20,000 is more preferred, because the “foil-off” properties at the time of transfer of the protective layer are improved.

### (Ultraviolet Absorbent)

In the protective layer transferring sheet in the invention, an ultraviolet absorbent may be incorporated into the protective layer and/or the adhesive layer. The ultraviolet absorbent may be an inorganic ultraviolet absorbent or organic ultraviolet absorbent known in the prior art.

As the organic ultraviolet absorbents, non-reactive ultraviolet absorbents can be used. Examples thereof include salicylate-series, benzophenone-series, benzotriazole-series, triazine-series, substituted acrylonitrile-series, and hindered amine-series ultraviolet absorbents; copolymers or graft polymers of thermoplastic resins (e.g., acrylic resins) obtained by introducing addition-polymerizable double bonds (eg., a vinyl group, an acryroyl group, a methacryroyl group), or an alcoholic hydroxyl group, an amino group, a carboxyl group, an epoxy group, or an isocyanate group, to the non-reactive ultraviolet absorbents, subsequently copolymerizing or grafting. In addition, disclosed is a method of obtaining ultraviolet-shielding resins by the steps of dissolving ultraviolet absorbents in a monomer or oligomer of the resin to be used, and then polymerizing the monomer or oligomer (JP-A-2006-21333). In this case, the ultraviolet absorbents may be non-reactive.

Of these ultraviolet absorbents, preferred are benzophenone-series, benzotriazole-series, and triazine-series ultraviolet absorbents. It is preferred that these ultraviolet absorbents are used in combination so as to cover an effective ultraviolet absorption wavelength region according to characteristic properties of the dye that is used for image formation. Besides, in the case of non-reactive ultraviolet absorbents, it is preferred to use a mixture of two or more kinds of ultraviolet absorbents each having a different structure from each other so as to prevent the ultraviolet absorbents from precipitation.

Examples of commercially available ultraviolet absorbents include TINUVIN-P (trade name, manufactured by Ciba-Geigy), JF-77 (trade name, manufactured by JOHOKU CHEMICAL CO., LTD.), SEESORB 701 (trade name, manufactured by SHIRAISHI CALCIUM KAISHA, LTD.), SUMISORB 200 (trade name, manufactured by Sumitomo Chemical Co., Ltd.), VIOSORB 520 (trade name, manufactured by KYODO CHEMICAL CO., LTD.), and ADKSTAB LA-32 (trade name, manufactured by ADEKA).

### (Curable Resins)

The use of ionizing radiation-curable resins or ultraviolet curable resins enables to obtain a protective Layer that excels in both resistance to plasticizers and scratch resistance in particular. As an example, there are resins that are obtained by cross-linking and curing radical polymerizable polymers or oligomers upon irradiation of ionizing radiation. At this moment, polymerization and cross-linking may be performed by adding a photopolymerization initiator in accordance with necessity, followed by irradiation of electron beam or ultraviolet ray. Further, known ionizing radiation-curable resins can be used.

### (Filler)

In the present invention, organic fillers and/or inorganic fillers can be preferably used. Examples of the organic fillers and/or the inorganic fillers include polyethylene wax, bis-amide, nylon, acrylic resin, cross-linked polystyrene, silicone resin, silicone rubber, talc, calcium carbonate, titanium oxide, alumina, and silica fine-particles such as micro silica and colloidal silica. In the heat-sensitive transfer sheet of the present invention, not only these exemplified materials, but also known other materials can be used suitably.

With respect to the organic fillers and/or the inorganic fillers, it is preferred that a particle diameter of the fillers is 10 μm or less, preferably in the range of from 0.1 μm to 3 μm, and the fillers have good sliding properties and high transparency. An addition amount of the filler is preferably not much more than a degree to which transparency is kept at the time of transfer. Specifically, the addition amount is preferably in the range of from 0 to 100 mass parts, based on 100 mass parts of the resin.

### (Formation of the Transferable Protective Layer)

The method for forming the protective layer, which depends on the kind of the resin to be used, may be the same method for forming the dye layer. The protective layer preferably has a thickness of 0.5 to 10 μm.

### (Releasing Layer)

In the case where the protective layer is not easily peeled from the support in the protective layer transferring sheet when the image is thermally transferred, a releasing layer may be formed between the support and the protective layer. A peeling layer may be formed between the transferable protective layer and the releasing layer. The releasing layer may be formed by painting a coating liquid by a method known in the prior art, such as gravure coating or gravure reverse coating, and then drying the painted liquid. The coating liquid contains at least one selected from, for example, waxes, silicone waxes, silicone resins, fluorine-contained resins, acrylic resins, polyvinyl alcohol resins, cellulose derivative resins, urethane resins, vinyl acetate resins, acrylic vinyl ether resins, maleic anhydride resins, and copolymers of these resins. Of these resins, preferred are: acrylic resins, such as resin obtained by homopolymerizing a (meth)acrylic monomer such as acrylic acid or methacrylic acid, or obtained by copolymerizing a methacrylic monomer with a different monomer; or cellulose derivative resins. Each of them excels in adhesive property to the support, and releasing ability from the protective layer.

These resins may be crosslinked with various crosslinking agents. Moreover, ionizing radiation curable resins and ultraviolet curable resins may be used.

The releasing layer may be appropriately selected from a releasing layer which is transferred to a transferred-image-receiving member when the image is thermally transferred, a releasing layer which remains on the support side at that time, a releasing layer which is broken out by aggregation at that time, and other releasing layers. A preferred embodiment of the invention is an embodiment wherein the releasing layer remains on the support side at the time of the thermal transfer and the interface between the releasing layer and the thermally transferable protective layer becomes a protective layer surface after the thermal transfer since the embodiment excels in surface gloss, the transfer stability of the protective layer, and others. The method for forming the releasing layer may be a painting method known in the prior art. The releasing layer preferably has a thickness of about 0.5 to 5 μm in the state that the layer is dried.

### (Adhesive Layer)

An adhesive layer may be formed, as the topmost layer of the transferable protective layer laminate, on the topmost surface of the protective layer. This makes it possible to make the adhesive property of the protective layer to a transferred-image-receiving member good.

### (Back Side Layer)

In the heat-sensitive transfer sheet that is used in the present invention, it is preferred to dispose a back side layer on the surface (back side) of the support opposite to the dye layer coating side of the support, namely on the same side as the surface with which a thermal head etc. contacts. Further, in the case of a protective layer transfer sheet, it is also preferred to dispose a back side layer on the surface (back side) of the support opposite to the transferable protective layer coating side of the support, namely on the same side as the surface with which a thermal head etc. contacts.

If the heat-sensitive transfer sheet is heated by a heating device such as a thermal head in the state such that the back side of the support of the transfer sheet directly contacts with the heating device, heat seal is apt to occur. In addition, owing to a large friction between them, it is difficult to smoothly transfer the heat-sensitive transfer sheet at the time of copying.

The back side layer is disposed so that the heat-sensitive transfer sheet enables to withstand heat energy from a thermal head. The back side layer prevents the heat seal, and enables a smooth travel action. Recently, the necessity of the back side layer is becoming greater on account that the heat energy from a thermal head is increasing in association with speeding-up of the printer.

The back side layer is formed by coating a composition wherein additives such as a sliding agent, a release agent, a surfactant, inorganic particles, organic particles, and pigments are added to a binder. Further, an interlayer may be disposed between the back side layer and the support. As the interlayer, there has been known a layer containing inorganic fine particles and a water-soluble resin or a hydrophilic resin capable of emulsification.

As the binder, there can be used known resins with high heat resistance. Examples of the binder include a single substance or a mixture of cellulose series resins such as ethyl cellulose, hydroxycellulose, hydroxypropylcellulose, methyl cellulose, cellulose acetate, cellulose acetate butyrate, cellulose acetate propionate, and nitrocellulose; polyvinyl series resins such as polyvinyl alcohol, polyvinyl acetate, polyvinyl butyral, polyvinyl acetal, polyvinyl acetoacetal resin, vinyl chloride-vinyl acetate copolymer, and polyvinyl pyrrolidone; acrylic resins such as polymethyl methacrylate, polyethyl acrylate, polyacrylamide, and acrylonitrile-styrene copolymer; polyamide resins, polyimide resins, polyamidoimide resins, polyvinyl toluene resins, cumarone indene resins, polyester resins, polyurethane resins, polyether resins, polybutadiene resins, polycarbonate resins, chlorinated polyolefin resins, fluorine resins, epoxy resins, phenolic resins, silicone resins, and natural or synthetic resins of silicone-modified or fluorine-modified urethane.

In order to enhance heat resistance of the back side layer, there have been known techniques of cross-linking resins by ultraviolet ray or electron beam radiation. Further, the resin may be cross-linked by heating with a cross-linking agent. According to need, catalyst may be added to the resin. As an exemplary cross-linking agent, poly isocyanate is known. When the poly isocyanate is used, a resin with a hydroxyl group-based functional group is suited to be cross-linked. JP-A-62-259889 discloses that a back side layer is formed of a reaction product of polyvinyl butyral and an isocyanate compound, to which a bulking agent such as an alkali metal salt or alkaline earth metal salt of phosphoric ester and potassium carbonate is added. JP-A-6-99671 discloses that a heat resistant lubricating layer-forming high molecular compound can be obtained by reacting a silicone compound having an amino group and an isocyanate compound having two or more isocyanate groups in a molecule.

Functions of the back side layer may be fully attained by adding thereto additives such as a sliding agent, a plasticizer, a stabilizer, a bulking agent, and filler for eliminating materials adhered on a head.

Examples of the sliding agent include fluorides such as calcium fluoride, barium fluoride and graphite fluoride; sulfides such as molybdenum disulfide, tungsten disulfide and iron sulfide; oxides such as lead oxide, alumina, and molybdenum oxide; solid sliding agents of inorganic compounds such as graphite, mica, boron nitride, and clays (e.g., talc, acid clay); organic resins such as fluorine resins and silicone resins; silicone oil; metal soaps such as metal salt of stearic acid; various kinds of waxes such as polyethylene wax and paraffin wax; and surfactants such as anionic surfactants, cationic surfactants, amphoteric surfactants, nonionic surfactants, and fluorine surfactants.

It is also possible to use phosphoric ester surfactants such as zinc salt of alkyl phosphoric monoester or alkyl phosphoric diester. However, the acid group of the phosphate causes a disadvantage such that the phosphate decomposes as a heat quantity from a thermal head becomes large, and consequently the pH of the back side layer reduces, corrosive abrasion of the thermal head becomes heavier. As a measure to deal with the disadvantage, there are known, for example, a method of using a neutralized phosphate surfactant, and a method of using a neutralizing agent such as magnesium hydroxide.

Examples of the other additives include higher fatty acid alcohol esters, organopolysiloxane, organic carboxylic acids and derivatives thereof, and fine particles of inorganic compounds such as tale and silica.

The back side layer is formed by adding the essential components and optional additives to the binder, examples of which have been described above, dissolving or dispersing the resultant into a solvent to prepare a coating liquid, and then painting the coating liquid by a known method such as gravure coating, roll coating, blade coating or wire bar coating. The film thickness of the back side layer is preferably from 0.1 to 10 μm, more preferably from 0.5 to 5 μm.

### (Support)

There is no particular limitation to the support for use of both the heat-sensitive transfer sheet and the protective layer transfer sheet that are used in the present invention. It is possible to use any one of supports known from the past, so long as they have sufficient heat resistance and strength.

As the support, polyamides and polyimides and polyesters are exemplified.

A thickness of the support can be properly determined in accordance with the material of the support so that the mechanical strength and the heat resistance become optimum. Specifically, it is preferred to use a support having a thickness of about 1 μm to about 100 μm, more preferably from about 2 μm to 50 μm, and further preferably from about 3 μm to about 10 μm.

### (Phosphorus Atom-Containing Compound)

It is preferred to contain a phosphorus atom-containing compound on the back side of the heat-sensitive transfer sheet that is used in the present invention. As the phosphorus atom-containing compound, phosphoric esters or monovalent metal salts thereof are preferred. The phosphoric esters are especially preferred.

With respect to the phosphoric esters and monovalent metal salts thereof, preferable embodiments are exemplified below. However, the present invention is not intended to be limited to these embodiments.

### Phosphoric Ester

The phosphoric ester is preferably a phosphoric ester wherein one of the three hydroxyl groups connected with the phosphorous atom in one phosphoric acid molecule is esterified (monoester) or two of the hydroxyl groups are esterified (diester) so that the hydroxyl group(s) not esterified remain(s).

The phosphoric ester is preferably a monoester or diester obtained by the reaction of a saturated or unsaturated alcohol having preferably 6 to 20 carbon atoms, more preferably 12 to 18 carbon atoms (such as stearyl alcohol or oleyl alcohol), with phosphoric acid.

The phosphoric ester is more preferably a monoester or diester obtained by the reaction of an alkylene oxide adduct of the above saturated or unsaturated alcohol with phosphoric acid. The alkylene oxide is preferably ethylene oxide. The addition number thereof is preferably from 1 to 20, more preferably from 1 to 8. When an alkyl group is bonded to the alkylene oxide, the alkyl group preferably has 6 to 20 carbon atoms.

Further, the phosphoric ester is preferably a monoester or diester obtained by the reaction of an aromatic alcohol having an alkyl group such as an alkylphenol or alkylnaphthol (specifically, nonylphenol, dodecylphenol or xylenylphenol) with phosphoric acid. The alkyl group bonded to the aromatic group of the aromatic alcohol has preferably has 6 to 20 carbon atoms.

The phosphoric ester is more preferably a monoester or diester obtained by the reaction of an alkylene oxide adduct of the above aromatic alcohol with phosphoric acid. The alkylene oxide is preferably ethylene oxide. The addition number thereof is preferably from 1 to 20, more preferably from 1 to 8. The alkyl group bonded to the aromatic ring of the aromatic alcohol has preferably 6 to 20 carbon atoms, more preferably 12 to 18 carbon atoms.

Of these compounds, furthermore preferred is a phosphoric monoester or phosphoric diester having an alkyl group having 12 to 18 carbon atoms.

### Monovalent Metal Salt of a Phosphoric Ester

The monovalent metal salt of a phosphoric ester means a compound wherein at least one hydrogen atom of the hydroxyl group(s) not esterified in a phosphoric ester is substituted by a monovalent metal atom. The monovalent metal is preferably an alkali metal, more preferably lithium, sodium or potassium, furthermore preferably sodium.

A monovalent metal salt of any one of the compounds listed up as the preferred embodiments of the above-mentioned phosphoric ester can be preferably used.

These compounds may be used in combination of two or more thereof.

The phosphoric ester and the monovalent metal salt of phosphoric ester described above can be preferably represented by the following formula (I):

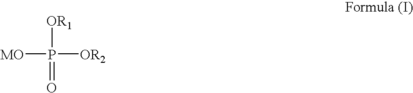

wherein M represents a hydrogen atom or a monovalent atom, R₁ represents a hydrogen atom, a monovalent metal, an alkyl group which may have a substituent, an alkenyl group which may have a substituent, or an aromatic group which may have a substituent, and R₂ represents an alkyl group which may have a substituent, an alkenyl group which may have a substituent, or an aromatic group which may have a substituent.

The monovalent metal is preferably the same as described above. The substituent which the alkyl, alkenyl or aromatic group as R₁ or R₂ may have may be any substituent, and is in particular preferably an alkyl group, an alkenyl group, an aromatic group, or —O—(CH₂CH₂O)ₙ—R₃ wherein n is an integer of 1 or more, preferably from 1 to 20, more preferably from 1 to 8, and R₃ is an alkyl group (having preferably 1 to 30 carbon atoms, more preferably 1 to 20 carbon atoms, and furthermore preferably 6 to 20 carbon atoms), an aryl group which may have a substituent (preferably, a phenyl group which may have a substituent, or a naphthyl group which may have a substituent, more preferably a phenyl group which may have a substituent, the substituent being preferably an alkyl group having 1 to 30 carbon atoms, preferably 1 to 20 carbon atoms, more preferably 6 to 20 carbon atoms, most preferably 8 to 18 carbon atoms).

In the formula (I), R₁ and R₂ may be the same or different. In the invention, R₁ and R₂ are preferably the same as each other.

Preferably, R₁ and R₂ each represent an alkyl group which may have a substituent, an alkenyl group which may have a substituent, or an aromatic group which may have a substituent. Preferred is a compound wherein R₂ is an alkyl group which may have a substituent, an alkenyl group which may have a substituent, or an aromatic group which may have a substituent; more preferred is a compound wherein R₂ is an alkyl group which may have a substituent; and most preferred is a compound wherein R₂ is an alkyl group having —O—(CH₂CH₂O)ₙ—R₃ as a substituent.

In particular, a compound wherein R₁ and R₂ are each —CH₂CH₂—O—(CH₂CH₂O)ₙ—R₃ is most preferable.

These phosphoric ester and the monovalent metal salt thereof may be used in combination of two or more thereof. For example, the following may be used together: a monoester of a phosphoric ester represented by the formula (I) wherein R₁ is a hydrogen atom or a monovalent metal, and R₂ is an alkyl group which may have a substituent, an alkenyl group which may have a substituent, or an aromatic group which may have a substituent; and a diester of a phosphoric ester represented by the formula (I) wherein R₁ and R₂ are each an alkyl group which may have a substituent, an alkenyl group which may have a substituent, or an aromatic group which may have a substituent. When the structure of R₁ and that of R₂ have each an alkyl group in the formula (I), compounds having alkyl groups the carbon atom numbers of which are different from each other may be used together. Compounds having, as R₁ and R₂, alkyl groups the carbon atom numbers of which are selected from the range of 6 to 20 and are different from each other are preferably used together. Compounds having, as R₁ and R₂, alkyl groups the carbon atom numbers of which are selected in the range of 8 to 18 and are different from each other are more preferably used together.

Many of these phosphoric esters are commercially available. Examples thereof include NIKKOL DLP-10, NIKKOL DOP-8NV, NIKKOL DDP-2, NIKKOL DDP-4, NIKKOL DDP-6, NIKKOL DDP-8, and NIKKOL DDP-10, (trade names, manufactured by Nikko Chemicals Co., Ltd.), PLYSURF A217 (trade name, manufactured by DAI-ICHI KOGYO SEIYAKYU Co., Ltd.).

Other examples of the phosphoric ester and the monovalent salt include dilauryl phosphate, dioleyl phosphate, distearyl phosphate, sodium di(polyoxyethylene nonyl ether) phosphate, di(polyoxyethylene dodecyl phenyl ether) phosphate, and sodium di(polyoxyethylene decyl phenyl ether) phosphate.

A preferable coating amount of these compounds is in the range of from 0.001 g/m²to 0.1 g/m², and more preferably from 0.01 g/m² to 0.05 g/m². These compounds are preferably added in a proportion of from 0.0001 to 0.01, and more preferably from 0.0005 to 0.005, in terms of ratio by mass based on the binder of the back side layer. If the addition amount is too small, it is difficult to achieve improvement in image uniformity that is an effect of the present invention. On the other hand, an excessive amount of additives causes with ease disadvantages such as reduction in release property of the back side, and stain on a thermal head.

### (Mg Compound)

It is preferred to contain Mg compounds on the back side of the heat-sensitive transfer sheet that is used in the present invention. Preferable examples of the Mg compounds include magnesium oxide, magnesium hydroxide, magnesium carbonate, magnesium sulfate, magnesium acetate, magnesium phosphate, magnesium silicate, magnesium citrate, and magnesium stearate. Of these compounds, magnesium oxide and magnesium hydroxide are especially preferred.

It is preferred to use the Mg compounds in the form of small size grains. The grain size is preferably in the range of from 0.1 μm to 5 μm, and more preferably from 0.5 μm to 2 μm.

A preferable coating amount of these compounds is in the range of from 0.01 g/m² to 0.5 g/m², and more preferably from 0.03 g/m² to 0.3 g/m². These compounds are preferably added in a proportion of from 0.001 to 0.1, and more preferably from 0.002 to 0.05, in terms of ratio by mass based on the binder of the back side layer. If the addition amount is too small, it is difficult to achieve improvement in image uniformity that is an effect of the present invention. On the other hand, an excessive amount of additives causes with ease disadvantages such as reduction in sliding property of the back side and abrasion of the thermal head.

The present invention enables to provide a heat-sensitive transfer image-receiving sheet which has achieved improvement in quality of the finished copy prints, improvement in transfer property of dyes and improvement in stability of the formed image, with a change of properties owing to reservation at the lapse of time of the image-receiving sheet being small, especially a heat-sensitive transfer image-receiving sheet having improved image uniformity. Further, an image-forming method and image prints produced thereby are also provided.

The present invention will be described in more detail based on the following examples, but the invention is not intended to be limited thereto. In the following examples, the terms “part(s)” and “%” are values by mass, unless otherwise specified.

### EXAMPLES

### Example 1

### (Preparation of Heat-Sensitive Transfer Sheet A)

A polyester film 6.0 μm in thickness (trade name: Diafoil K200E-6F, manufactured by MITSUBISHI POLYESTER FILM CORPORATION), that was subjected to an easy-adhesion-treatment on one surface of the film, was used as a support. The following back side-layer coating liquid was applied onto the support on the other surface that was not subjected to the easy-adhesion-treatment, so that the coating amount based on the solid content after drying would be 1 g/m². After drying, the coating liquid was cured by heat at 60° C.

Heat-sensitive transfer sheet A was prepared by coating the following coating liquids on the easy-adhesion layer coated side of the thus-prepared polyester film so that a yellow heat transfer layer, a magenta heat transfer layer, a cyan heat transfer layer, and a transferable protective layer laminate would be disposed in area order. The coating amount of each dye layer based on the solid content was 0.95 g/m².

The transferable protective layer laminate was prepared by the following procedure: (1) applying and drying of a releasing layer-coating liquid on the substrate, (2) applying and drying of a protective layer-coating liquid on the dried releasing layer, and (3) applying and drying of an adhesion layer-coating liquid on the dried protective layer.

| | |
|---|---|
| Back side layer-coating liquid | |
| Acrylic-series polyol resin (trade name: | 26.0 mass parts |
| ACRYDIC A-801, | |
| manufactured by Dainippon Ink and Chemicals, | |
| Incorporated) | |
| Zinc stearate (trade name: SZ-2000, manufactured by | 0.43 mass part |
| Sakai Chemical Industry Co., Ltd.) | |
| Phosphoric ester (trade name: PLYSURE A217, | 1.27 mass parts |
| manufactured by Dai-ichi Kogyo Seiyaku Co., Ltd.) | |
| Isocyanate (50% solution) (trade name: | 8.0 mass parts |
| BURNOCK D-800, manufactured by Dainippon Ink and | |
| Chemicals, Incorporated) | |
| Methyl ethyl ketone/Toluene (2/1, at mass ratio) | 64 mass parts |
| Yellow dye layer-coating liquid | |
| Dye compound (Y-1) | 4.0 mass parts |
| Dye compound (Y-2) | 4.0 mass parts |
| Polyvinylacetal resin (trade name: ESLEC KS-1, | 6.2 mass parts |
| manufactured by Sekisui Chemical Co., Ltd.) | |
| Polyvinylbutyral resin (trade name: | 2.2 mass parts |
| DENKA BUTYRAL #6000-C, manufactured by | |
| DENKI KAGAKU KOGYOU K. K.) | |
| Release agent (trade name: X-22-3000T, | 0.05 mass part |
| manufactured by Shin-Etsu Chemical Co., Ltd.) | |
| Release agent (trade name: TSF4701, | 0.03 mass part |
| manufactured by MOMENTIVE Performance | |
| Materials Japan LLC.) | |
| Matting agent (trade name: Flo-thene UF, | 0.14 mass part |
| manufactured by Sumitomo Seika Chemicals Co., Ltd.) | |
| Methyl ethyl ketone/Toluene (2/1, at mass ratio) | 83 mass parts |
| Y-1 | |
| 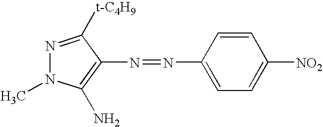 | |
| Y-2 | |
| 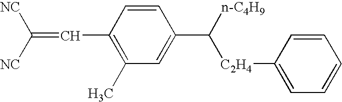 | |
| Magenta dye layer-coating liquid | |
| Dye compound (M-1) | 0.7 mass part |
| Dye compound (M-2) | 0.8 mass part |
| Dye compound (M-3) | 6.3 mass parts |
| Polyvinylacetal resin (trade name: ESLEC KS-1, | 8.4 mass parts |
| manufactured by Sekisui Chemical Co., Ltd.) | |
| Polyvinylbutyral resin (trade name: DENKA BUTYRAL | 0.2 mass part |
| #6000-C, manufactured by | |
| DENKI KAGAKU KOGYOU K. K.) | |
| Release agent (trade name: X-22-3000T, manufactured | 0.05 mass part |
| by Shin-Etsu Chemical Co., Ltd.) | |
| Release agent (trade name: TSF4701, manufactured by | 0.03 mass part |
| MOMENTIVE Performance Materials Japan LLC.) | |
| Matting agent (trade name: Flo-thene UF, | 0.15 mass part |
| manufactured by Sumitomo Seika Chemicals Co., Ltd.) | |
| Methyl ethyl ketone/Toluene (2/1, at mass ratio) | 84 mass parts |
| M-1 | |
| 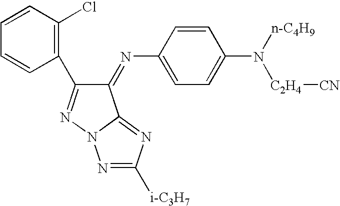 | |
| M-2 | |
| 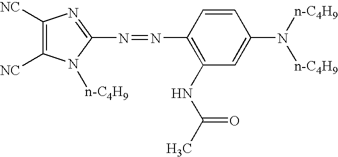 | |
| M-3 | |
| 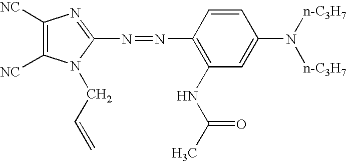 | |
| Cyan dye layer-coating liquid | |
| Dye compound (C-1) | 1.3 mass parts |
| Dye compound (C-2) | 6.2 mass parts |
| Dye compound (C-3) | 0.3 mass part |
| Polyvinylacetal resin (trade name: ESLEC KS-1, | 7.1 mass parts |
| manufactured by Sekisui Chemical Co., Ltd.) | |
| Polyvinylbutyral resin (trade name: DENKA BUTYRAL | 0.8 mass part |
| #6000-C, manufactured by | |
| DENKI KAGAKU KOGYOU K. K.) | |
| Release agent (trade name: X-22-3000T, | 0.05 mass part |
| manufactured by Shin-Etsu Chemical Co., Ltd.) | |
| Release agent (trade name: TSF4701, | 0.03 mass part |
| manufactured by MOMENTIVE Performance Materials | |
| Japan LLC.) | |
| Matting agent (trade name: Flo-thene UF, | 0.15 mass part |
| manufactured by Sumitomo Seika Chemicals Co., Ltd.) | |
| Methyl ethyl ketone/Toluene (2/1, at mass ratio) | 83 mass parts |
| C-1 | |
| 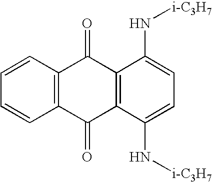 | |
| C-2 | |
| 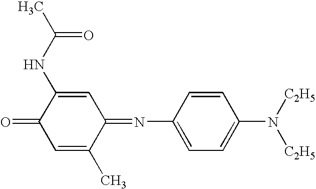 | |
| C-3 | |
| 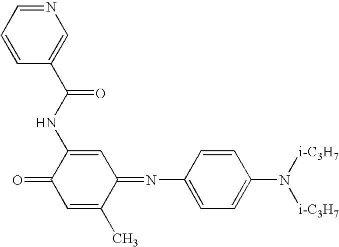 | |

### (Transfer Protective Layer Laminate)

On the same polyester film as used in the preparation of the dye layers as described above, coating liquids of a releasing layer, a protective layer and an adhesive layer each having the following composition was coated, to form a transfer protective layer laminate. Coating amounts of the releasing layer, the protective layer and the adhesive layer after drying were 0.3 g/m², 0.6 g/m² and 2.2 g/m², respectively.

| | |
|---|---|
| Releasing layer-coating liquid | |
| Modified cellulose resin (trade name: L-30, manufactured | 5.5 mass parts |
| by DAICEL CHEMICAL INDUSTRIES, LTD.) | |
| Methyl ethyl ketone | 94.5 mass parts |
| Protective layer-coating liquid | |
| Acrylic resin solution (Solid content: 40%) | 85 mass parts |
| (trade name: UNO-1, manufactured by Gifu | |
| Ceramics Limited) | |
| Methanol/Isopropanol (1/1, at mass ratio) | 15 mass parts |
| Adhesive-layer-coating liquid | |
| Acrylic resin (trade name: DIANAL BR-77, | 23 mass parts |
| manufactured by MITSUBISHI RAYON CO., LTD.) | |
| The following ultraviolet absorbent UV-1 | 1 mass part |
| The following ultraviolet absorbent UV-2 | 2 mass parts |
| The following ultraviolet absorbent UV-3 | 1 mass part |
| The following ultraviolet absorbent UV-4 | 1 mass part |
| PMMA fine particles (polymethyl methacrylate fine | 0.4 mass part |
| particles) | |
| Methyl ethyl ketone/Toluene (2/1, at mass ratio) | 72 mass parts |

(UV-1)

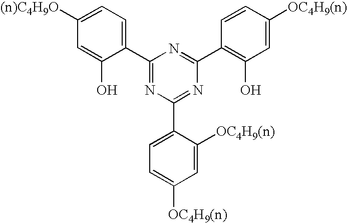

(UV-2)

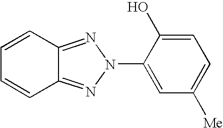

(UV-3)

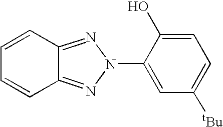

(UV-4)

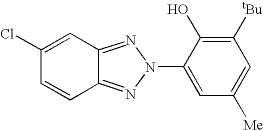

### (Preparation of Heat-Sensitive Transfer Sheet B)

Heat-sensitive transfer sheet B was prepared in the same manner as heat-sensitive transfer sheet A, except that the composition of the back side layer-coating liquid was changed to the following composition.

[Preparation of back side layer-coating liquid]

| | |
|---|---|
| Acrylic-series polyol resin (trade name: | 25.0 mass parts |
| ACRYDIC A-801, manufactured by Dainippon Ink and | |
| Chemicals, Incorporated) | |
| Zinc stearate (trade name: SZ-2000, | 0.43 mass part |
| manufactured by Sakai Chemical Industry Co., Ltd.) | |
| Phosphate (trade name: PLYSURF A217E, | 1.27 mass parts |
| manufactured by Dai-ichi Kogyo Seiyaku Co., Ltd.) | |
| Isocyanate (50% solution) (trade name: | 8.0 mass parts |
| BURNOCK D-800, manufactured by Dainippon Ink and | |
| Chemicals, Incorporated) | |
| Methyl ethyl ketone/Toluene (2/1, at mass ratio) | 65 mass parts |
| Talc (trade name: MICRO ACE P-4, | 0.22 mass part |
| manufactured by NIPPON TALC Co., Ltd.) | |
| Magnesium oxide (trade name: Kyowamag MF-30, | 0.06 mass part |
| manufactured by Kowa Chemical Industry Co., Ltd.) | |

### (Preparation of Heat-Sensitive Transfer Image-Receiving Sheet 101)

A paper support, on both sides of which polyethylene was laminated, was subjected to corona discharge treatment on the surface thereof and then a gelatin undercoat layer containing sodium dodecylbenzenesulfonate was disposed on the treated surface. The subbing layer, the heat insulation layer, the lower receptor layer and the upper receptor layer each having the following composition were multilayer-coated on the gelatin undercoat layer, in the state that the subbing layer, the heat insulation layer, the lower receptor layer and the upper receptor layer were laminated in this order from the side of the support, by a method illustrated in FIG. 9 in U.S. Pat. No. 2,761,791. The coating was performed so that coating amounts of the subbing layer, the heat insulation layer, the lower receptor layer, and the upper receptor layer after drying would be 6.5 g/m², 8.9 g/m², 2.5 g/m² and 2.5 g/m², respectively. The following compositions are expressed by mass as a solid content.

| | |
|---|---|
| Upper layer of the receptor layer | |
| Vinyl chloride-series latex (trade name: VINYBLAN | 22.0 mass parts |
| 900, manufactured by Nisshin Chemicals Co., Ltd.) | |
| Vinyl chloride-series latex (trade name: VINYBLAN | 2.6 mass parts |
| 276, manufactured by Nisshin Chemicals Co., Ltd.) | |
| Gelatin (10% solution) | 2.1 mass parts |
| Ester-series wax EW-1 presented below | 2.0 mass parts |
| Surfactant F-1 presented below | 0.07 mass part |
| Surfactant F-2 presented below | 0.36 mass part |
| Lower layer of the receptor layer | |
| Vinyl chloride-series latex (trade name: VINYBLAN | 13.5 mass parts |
| 690, manufactured by Nisshin Chemicals Co., Ltd.) | |
| Vinyl chloride-series latex (trade name: VINYBLAN | 13.5 mass parts |
| 900, manufactured by Nisshin Chemicals Co., Ltd.) | |
| Gelatin (10% solution) | 10.5 mass parts |
| Surfactant F-1 presented below | 0.04 mass part |
| Heat insulation layer | |
| Hollow latex polymer (trade name: MH5055, | 58.0 mass parts |
| manufactured by Nippon Zeon Co., Ltd.) | |
| Gelatin (10% solution) | 55.0 mass parts |
| Subbing layer | |
| Polyvinyl alcohol (trade name: Poval PVA205, | 6.7 mass parts |
| manufactured by KURARY CO., LTD.) | |
| Styrene-Butadiene rubber latex (trade name: SN-307, | 62.0 mass parts |
| manufactured by NIPPON A&L INC.) | |
| Surfactant F-1 presented below | 0.03 mass part |

(EW-1)

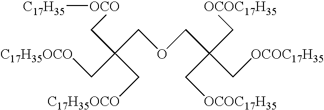

(F-1)

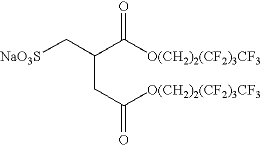

F-2

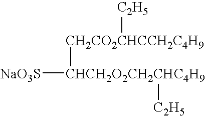

### (Preparation of Heat-Sensitive Transfer Image-Receiving Sheet 102)

Heat-sensitive transfer image-receiving sheet 102 was prepared in the same manner as the heat-sensitive transfer image-receiving sheet 101, except that K-1 set forth below was added to the heat insulation layer of the heat-sensitive transfer image-receiving sheet 101 in an amount of 1.0% by mass.

### (Preparation of Heat-Sensitive Transfer Image-Receiving Sheet 103)

Heat-sensitive transfer image-receiving sheet 103 was prepared in the same manner as the heat-sensitive transfer image-receiving sheet 101, except that K-1 set forth below was added to the heat insulation layer of the heat-sensitive transfer image-receiving sheet 101 in an amount of 1.7% by mass.

### (Preparation of Heat-Sensitive Transfer Image-Receiving Sheet 104)

Heat-sensitive transfer image-receiving sheet 104 was prepared in the same manner as the heat-sensitive transfer image-receiving sheet 101, except that a content of gelatin (10% aqueous solution) in the heat insulation layer of the heat-sensitive transfer image-receiving sheet 101 was changed from 55.0% by mass to 46% by mass, and K-1 set forth below was added to the heat insulation layer in an amount of 1.4% by mass.

### (Preparation of Heat-Sensitive Transfer Image-Receiving Sheet 105)

Heat-sensitive: transfer image-receiving sheet 105 was prepared in the same manner as the heat-sensitive transfer image-receiving sheet 101, except that a content of gelatin (10% aqueous solution) in the heat insulation layer of the heat-sensitive transfer image-receiving sheet 101 was changed from 55.0% by mass to 37% by mass, and K-1 set forth below was added to the heat insulation layer in an amount of 1.2% by mass.

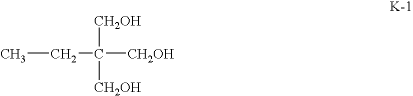

### (Preparation of Heat-Sensitive Transfer Image-Receiving Sheet 001)

As a heat insulation layer, a biaxially oriented polypropylene film (TOYOPEARL SS P4255, thickness 35 μm, manufactured by TOYOBO) was used.

On one side of the heat insulation layer was coated with a 0.1 g/m² primer layer having the following composition and a 5.5 g/m² receptor layer having the following composition using a gravure printer. The coating amounts are values after drying.

Primer layer-coating liquid composition

| | |
|---|---|
| Urethane resin | 50 mass parts |
| (DP Urethane: a product of Showa Ink Manufacturing | |
| Co., Ltd.) | |
| Hardening agent | 1 mass part |
| (CORONATE 2030: a product of Nippon Polyurethane | |
| Industry Co., Ltd.) | |
| Methyl ethyl ketone/Toluene (1/1, at mass ratio) | 30 mass parts |

Receptor layer-coating liquid composition

| | |
|---|---|
| Vinyl chloride/vinyl acetate copolymer (trade name: | 65 mass parts |
| DENKA VINYL #1000A, manufactured by | |
| DENKI KAGAKU KOGYOU K. K.) | |
| Polyester (trade name: VYLON 600, | 35 mass parts |
| manufactured by Toyobo Co., Ltd.) | |
| Amino-modified silicone (Trade name: X22-3050C, | 3 mass parts |
| manufactured by Shin-Etsu Chemical Co., Ltd.) | |
| Epoxy-modified silicone (Trade name: X22-300E, | 2 mass parts |
| manufactured by Shin-Etsu Chemical Co., Ltd.) | |
| Methyl ethyl ketone/Toluene (1/1, at mass ratio) | 60 mass parts |

The back side layer having the following composition was coated on one side of a coat paper using a gravure printer so as to make the coating amount after drying to be 5.0 g/m².

Back side layer-coating liquid composition

| | |
|---|---|
| Acrylic resin | 15 mass parts |
| (BR-85: a product of Mitsubishi Rayon) | |
| Methylethyl ketone/toluene (1/1, at mass ratio) | 85 mass parts |

Subsequently, the adhesive layer having the following composition was coated on the other side of the coat paper using a gravure printer so as to make the coating amount after drying to be 5.0 g/m².

Adhesive layer-coating liquid composition

| | |
|---|---|
| Polyester adhessive | 85 mass parts |
| (SK-DYNE 5273: a product of Soken Chemical & | |
| Engineering Co., Ltd.) | |
| Methylethyl ketone/Toluene/Ethyl acetate | 25 mass parts |
| (1/1/1, at mass ratio) | |
| Polyethylene Filler (Average grain size 5 μm) | 70 mass parts |

The adhesive-coating side of the coat paper was superposed on the other side of the biaxially oriented polypropylene film that is opposite to the receptor layer-coating side, and then they were subjected to dry lamination at a heating temperature of 70° C. for a press time of 15 sec. so that they could adhere to each other. Thus, the heat-sensitive transfer image-receiving sheet 001 was prepared.

### (Preparation of Heat-Sensitive Transfer Image-Receiving Sheet 002)

As a heat insulation layer, a biaxially oriented polypropylene film (TOYOPEARL SS P4255, thickness 35 μm, manufactured by TOYOBO) was used.

A 2.5 g/m² under layer and a 2.5 g/m² upper layer of the receptor layer of the heat-sensitive transfer image-receiving sheet 101 were coated on one side of the heat insulation layer, followed by drying.

A back side layer and an adhesive layer were coated on one side of the coat paper in the same manner as preparation of the heat-sensitive transfer image-receiving sheet 001. The adhesive-coating side of the coat paper was superposed on the other side of the biaxially oriented polypropylene film that is opposite to the receptor layer-coating side, and then they were subjected to dry lamination at a heating temperature of 70° C. for a press time of 15 sec. so that they could adhere to each other. Thus, the heat-sensitive transfer image-receiving sheet 002 was prepared.

### (Measurement of Vickers Hardness)

Measurement of Vickers hardness was conducted by forming a single layer film on a glass plate. With respect to each of the heat insulation layers formed with using aqueous coating liquids (i.e. the heat insulation layers in the heat-sensitive transfer image-receiving sheets 101 to 105), a 35 μm single layer film was coated on a glass plate and then dried, and which was used for measurement. With respect to each of the heat insulation layers of the heat-sensitive transfer image-receiving sheets 001 and 002, the biaxially oriented polypropylene film was adhered on a glass plate with using the adhesive, and which was used for measurement.

Measurement was conducted using a full automatic micro Vickers hardness-meter system (trade name: HMV-FA, manufactured by Shimadzu). The Vickers hardness was calculated according to the following universal hardness computing equation, based on the applied load and indentation depth of an indenting tool that is obtained by applying a load to the indenting tool.

Vickers hardness UHV=37.838×P/(D×D)

wherein P represents a test load (m N), and D represents an indentation depth (μm).

The test conditions were as follows.

100 m N of test load was applied with the Vickers indenting tool at the speed of 10 m N/sec. A speed at which the test load was applied was 10 m N/sec.

### (Image Formation)

An image with a size of 152 mm×102 mm was output using the above-described ink sheet and image-receiving sheet, by means of a thermal transfer type printer A (ASK-2000, manufactured by FUJIFILM Corporation). Herein, a traveling rate of the thermal transfer type printer A was 0.73 msec/line. Printing was performed under the ordinary humidity condition of 25° C. and 60% RH and the low humidity condition of 25° C. and 20% RH, respectively.

### (Evaluation of Image Uniformity)

Five (5) copies of the print with a visual density of 0.4 were successively output, and then the thus-copied prints were evaluated by naked eye. The evaluation was conducted by five estimators according to the following criteria. The average value of the evaluation was calculated. The results were shown in Table 1 set forth below.
1: Image turbulence is intensely appeared on the print.
2: Image turbulence is appeared on the print at a practically troublesome level.
3: Image turbulence is appeared on the print, but practically no problems.
4: Almost no image turbulence is appreciated on the print.
5: No image turbulence is appreciated on the print.

TABLE 1

| | Heat-sensitive transfer image-receiving | | | | | |
|---|---|---|---|---|---|---|
| | sheet | | | Heat-sensitive | | |
| | | Hardness | Moisture content | transfer sheet | Image uniformity | |
| Test No. | No. | (×10⁹ N/m²) | (mass %) | No. | 25° C. 60% RH | 25° C. 20% RH |
| Test 1 (Comparative example) | 101 | 42 | 5.2 | A | 2.2 | 1.4 |
| Test 2 (Comparative example) | 102 | 27 | 5.3 | A | 2.9 | 1.9 |
| Test 3 (This invention) | 103 | 18 | 5.2 | A | 3.9 | 3.0 |
| Test 4 (This invention) | 104 | 13 | 5.2 | A | 4.2 | 3.4 |
| Test 5 (This invention) | 105 | 8 | 5.3 | A | 4.6 | 3.7 |
| Test 6 (Comparative example) | 001 | 5 | 3.6 | A | 3.9 | 2.5 |
| Test 7 (Comparative example) | 002 | 5 | 4.2 | A | 4.0 | 2.7 |
| Test 9 (This invention) | 105 | 8 | 5.3 | B | 4.6 | 4.3 |

It is apparent from the above Table 1 that the tests according to the present invention are improved in image uniformity compared to that of the comparative examples. Further, it is understood that usage of the heat-sensitive transfer sheet having a Mg compound and a phosphorus atom-containing compound on the back side of the support further improves image uniformity.

Having described our invention as related to the present embodiments, it is our intention that the invention not be limited by any of the details of the description, unless otherwise specified, but rather be construed broadly within its spirit and scope as set out in the accompanying claims.

What we claim is:

1. A heat-sensitive transfer image-receiving sheet having at least one receptor layer and at least one heat insulation layer on a support, wherein a Vickers hardness of the heat insulation layer is in the range of from 2 to 20, and a moisture content of the heat-sensitive transfer image-receiving sheet is in the range of from 5% by mass to 8% by mass.

2. An image-forming method which comprises contacting a heat-sensitive transfer image-receiving sheet having at least one receptor layer and at least one heat insulation layer on a support with a heat-sensitive transfer sheet having at least one yellow dye layer, at least one magenta dye layer and at least one cyan dye layer on a support, and then heating them to form a dye image on the receptor layer, wherein a Vickers hardness of the heat insulation layer of the heat-sensitive transfer image-receiving sheet is in the range of from 2 to 20, and a moisture content of the heat-sensitive transfer image-receiving sheet is in the range of from 5% by mass to 8% by mass.

3. The image-forming method as described in claim 2, wherein a back side of the support contains at least one Mg compound and at least one phosphorus atom-containing compound.

4. An image print wherein the image is formed according to the image-forming method as described in claim 2.
